(19) United States
(12) Patent Application Publication
(10) Pub. No.: US 2006/0011564 A1
(43) Pub. Date: Jan. 19, 2006

(54) Multiple receptacle item organizer

(76) Inventor: Emmanuel Hatzis, Chicago, IL (US)

Correspondence Address: James Earl Lowe, Jr., 15417 W. National Ave., # 300, New Berlin, WI, 53151, US

(21) Appl. No.: 11/180,260

(22) Filed: Jul. 13, 2005

Related U.S. Application Data
(60) Provisional application No. 60/587,695, filed on Jul. 14, 2004.

(51) Int. Cl. B42F 17/00

(52) U.S. Cl. 211/10

(57) ABSTRACT

An organizer including a cabinet comprising a bottom wall, a pair of opposed sidewalls, a top wall, and a back wall. The organizer also includes an upper horizontal dividing wall, a lower horizontal dividing wall, and eight box-shaped open-faced item bins. The organizer further includes a plurality of key hooks, a pen and pencil compartment, a small card compartment and an envelope compartment.

### CONTINUING DATA

This application claims priority from U.S. Provisional Patent Application 60/587,695 filed Jul. 14, 2004.

### BACKGROUND OF THE INVENTION

The present invention relates to a home or office organizer and, more particularly, relates to a mail, assorted papers, keys and items organizer.

The use of mail organizing devices is known in the prior art. By way of example, U.S. Pat. No. 5,564,624 to Davis, Jr. discloses a multiple receptacle mail organizing system.

While these devices fulfill their respective, particular objective and requirements, the prior art patents do not describe an item organizer that allows mail of a family or other group of individuals to be organized in one central location, along with other home or office items, such as envelopes, keys, pencils and newspapers.

In this respect, the item organizer according to the present invention substantially departs from the conventional concepts and designs of the prior art.

### SUMMARY OF THE INVENTION

The organizer of this invention includes a cabinet comprising a bottom wall, a pair of opposed sidewalls, a top wall, and a back wall. The organizer also includes an upper horizontal dividing wall, a lower horizontal dividing wall, and several box-shaped open-faced item bins.

The organizer is a simple way to organize a complicated lifestyle. Along the sides of the organizer are 4 or more hooks to hang keys or other small necessities. On one side are two pockets, used for items such as pens and pencils, stamps, outgoing mail, etc. On the opposing side there is a slot fit for envelopes or other items of that size. Many more things could be added on the organizer. All pockets may be used for whatever purpose the consumer desires. The organizer can be made to fit almost any measurements that are requested. It can also be made in different shapes and sizes.

It is therefore an object of the present invention to permit individuals to organize and keep account of all mail, bills, magazines, catalogs, stamps, envelopes, newspapers, keys, etc. The item organizer helps families or groups quickly systemize their mail and other useful documents. The organizer can be personalized to meet every categorizing need with side hooks to hang keys, and easy to reach compartments for small necessities such as pens and pencils, envelopes, stamps, receipts.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a perspective view of the preferred embodiment of an organizer constructed in accordance with the principles of the present invention.

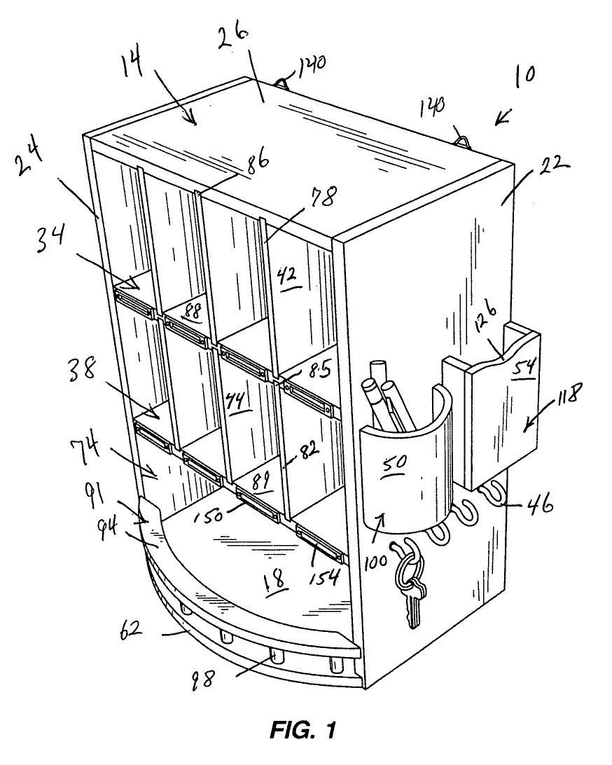

FIG. 2 is a perspective view of another side of the organizer of FIG. 1.

FIG. 3 is a lower perspective view of the organizer of FIG. 1.

FIG. 4 is a perspective view of the back of the organizer of FIG. 1.

Before one embodiment of the invention is explained in detail, it is to be understood that the invention is not limited in its application to the details of the construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience in reference to the drawings and are not to be construed as limiting terms.

### DETAILED DESCRIPTION OF THE PREFERRED EMBODIMENT

With reference now to the drawings, the preferred embodiment of the new and improved mail organizer embodying the principles and concepts of the present invention and generally designated by the reference number 10 will be described.

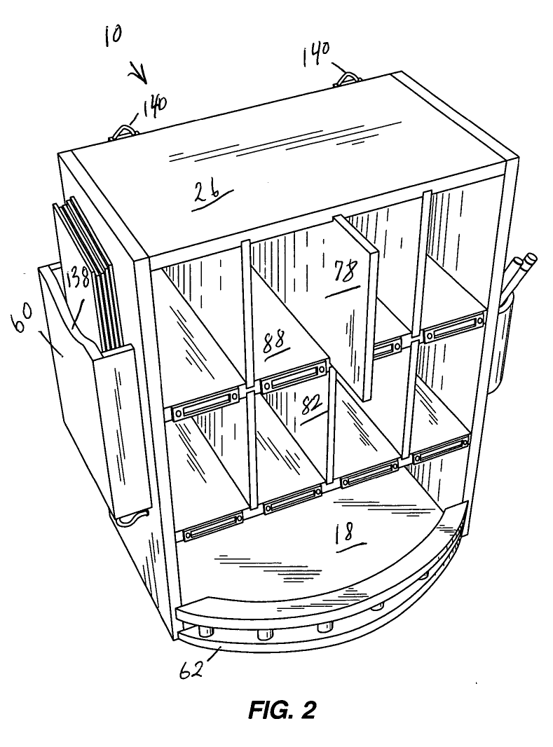

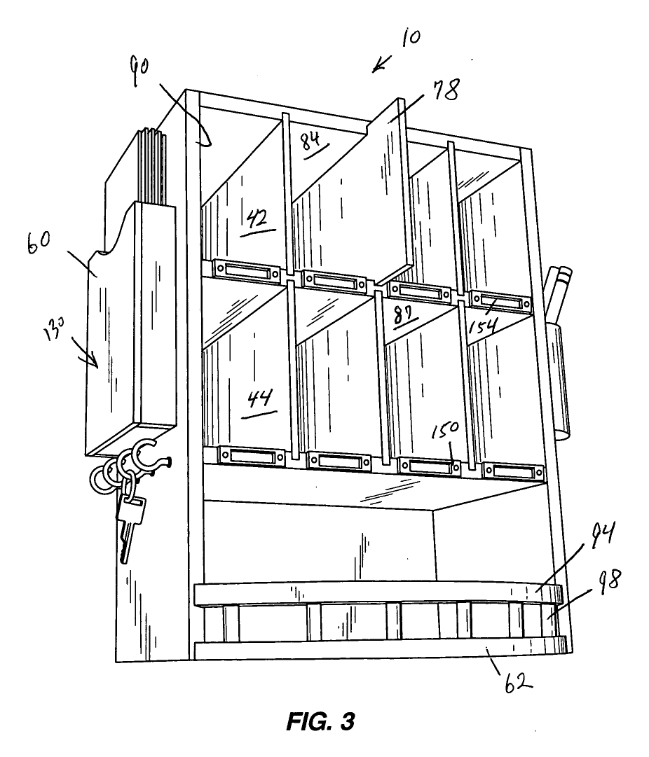

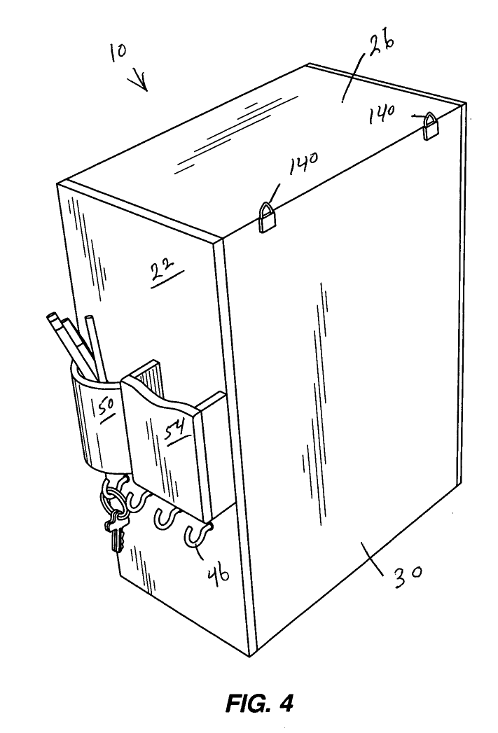

The preferred embodiment of the present invention includes a plurality of components. In their broadest context, the components include a cabinet 14 comprising a bottom wall 18, a pair of opposed sidewalls 22 and 24, a top wall 26, and a back wall 30 (see FIG. 4). The cabinet 14 also includes an upper horizontal dividing wall 34, a lower horizontal dividing wall 38, and eight box-shaped open-faced item bins 42 and 44. The organizer further includes a plurality of key hooks 46, a pen and pencil compartment 50, a small card compartment 54 and an envelope compartment 60 (see FIGS. 2 and 3). All of the above, except for the key hooks 46, which are metal, are made from any choice of wood type with a desired color stain. The cabinet 14 can also be made from any other material such as plastic, metal, glass etc.

Such components are individually configured and correlated with respect to each other to provide a structure that allows various items to be organized for an individual, a family or other group of individuals.

More particularly, the bottom wall 18 is horizontal, rectangular, and planar with an added curved front planar edge 62, a rear edge, and opposed side edges. The sidewalls 22 and 24 are opposed rectangular planar pieces attached to and extending upwards from the side edges of the bottom wall 18. The top wall 26 is horizontal, rectangular, and planar and is attached to an upper edge of each of the sidewalls 22 and 24. The back wall 30 is also planar and is connected between the sidewalls 22 and 24, the top wall 26, and the bottom wall 18 to define a hollow compartment 74. The upper horizontal rectangular planar dividing wall 34 is spaced apart below the top wall 26 and extends between and is attached to the sidewalls 22 and 24 and the back wall 30. The lower horizontal rectangular planar dividing wall 38 is spaced apart below the top wall 26 and also extends between and is also attached to the sidewalls 22 and 24 and the back wall 30.

An upper sequential arrangement of four box-shaped item bins 42 is provided within the hollow compartment 74 between the top wall 26 and the upper dividing wall 34. The upper sequential item bins 42 are defined by removable partitions 78, each partition 78 being removably in vertically aligned slots 86 in the upper dividing wall top surface 84 (see FIG. 3) and the top wall bottom surface 88. A lower sequential arrangement of four box-shaped item bins 44 is also provided within the hollow compartment 74 between the upper dividing wall 34 and the lower dividing wall 38. The lower sequential item bins 44 are defined by removable partitions 82, each partition 82 being removably received in vertically aligned slots 85 in the upper dividing wall bottom surface 87 (see FIG. 3) and the lower dividing wall top surface 89. All of the item bins 42 and 44 can used for holding a selected individual or more items, and each of these item bins has a rectangular front opening 90 see FIG. 3). More or less bins can be selected by removing one or more of the partitions 78 and 82.

The cabinet 14 further includes a railing 91 for preventing items from easily sliding out of the bottom extent of the hollow compartment 74. The railing 91 is formed from a curved top strip 94 and a plurality of spaced apart cylindrical posts 98 extending vertically between the top strip 94 and the bottom wall curved front edge 62. Thus the lower portion of the organizer 10 can be used, for example, as a newspaper and magazine rack, or to hold a bowl (not shown) to contain miscellaneous items, such as coins, paper clips, etc.

Attached to each of the side walls 22 and 24 is the plurality of key hooks 46, and attached to one side wall 22 is the first or pen and pencil compartment 50 comprising a curved outer wall 100 with opposed vertically extending side edges attached to the one side wall 22, a planar bottom wall with a curved outer edge attached to the pen and pencil compartment outer wall 100, and a straight edge attached to the one side wall 22. Also attached to this one side wall 22 is the second or small card compartment 54 with a outer planar rectangular wall 118, a pair of planar rectangular side walls attached to the one side wall 22 and to the small card compartment outer wall 118, and a bottom planar rectangular wall attached to both of the small card compartment side walls and the small card compartment outer wall 118. The top edge of the small card compartment outer wall is notched 126 to provide easier access to any cards within the small card compartment. The small card compartment 54 can also be used for storing stamps and receipts, among other items.

The pen and pencil compartment 50 and the small card compartment 54 sit in front to back horizontal order in about the middle of the one sidewall 22, with the key hooks 46 located beneath the compartments. The top and bottom edges of the pen and pencil compartment 50 and the small card compartment 54 lie in about the same horizontal top and bottom planes, respectively.

As shown in FIGS. 2 and 3, attached to the other side wall 24 is the third or envelope compartment 60 with a outer planar rectangular wall 130, a pair of planar rectangular side walls attached to the other side wall 24 and to the envelope compartment outer wall 130, and a bottom planar rectangular wall attached to both of the envelope compartment side walls and the envelope compartment outer wall 130. The top edge of the envelope compartment outer wall 130 is notched 138 to provide easier access to any envelopes within the envelope compartment 60. The bottom of the envelope compartment 60 sits about one third of the way up the other side wall 24, with the key hooks 46 are located beneath the envelope compartment 60. The envelope compartment 60 is about twice as long as the small card compartment 54 and about one third wider.

Means for also provided for permitting the cabinet to be hung on an office or home wall is also attached to the cabinet. In the preferred embodiment, such hanging means is in the form of two spaced apart triangular-shaped wires 140 pivotally attached to the top of the back wall 30.

The organizer further includes means for labeling each of the item bins, such labeling means being in the form of tag receiving metal or plastic rectangular frames 150, each of which is attached to the front face of a dividing wall beneath each bin. A tag or label 154 may then be marked appropriately and then placed in a respective frame 150. Thus, the bins can be personalized for names, categories, etc.

The organizer 10 stands about 24 inches high, and can be mounted or left to be free standing on a counter top (not shown) or where ever the consumer pleases.

Various other features and advantages of the invention will be apparent from the following claims.

1. An organizer including a cabinet comprising a horizontal bottom wall with a front edge, a rear edge, and opposed side edges, a pair of opposed side walls attached to and extending upwards from the side edges of the bottom wall, a horizontal top wall attached to an upper extent of each side wall, and a back wall connected between the side walls, the top wall, and the bottom wall to define a hollow compartment,
an upper horizontal dividing wall spaced apart below the top wall and extending between and attached to the sidewalls and the back wall,
an upper sequential arrangement of at least two box-shaped open-faced item bins is provided within a central extent of the compartment between the top wall and the upper dividing wall, the upper sequential item bins being defined by partitions, each partition being received between the upper dividing wall top surface and the top wall bottom surface,
a plurality of key hooks attached to a sidewall,
a first compartment attached to one side wall and comprising a outer wall with opposed vertically extending side edges attached to the one side wall, a bottom wall with a outer edge attached to the first compartment outer wall, and a straight edge attached to the one side wall, and
a second compartment attached to this one sidewall and including an outer wall, a pair of sidewalls attached to the one side wall and to the second compartment outer wall, and a bottom wall attached to both of the second compartment side walls and the second compartment outer wall.

2. An organizer in accordance with claim 1 wherein said organizer further includes a lower horizontal dividing wall spaced apart below the top wall and extending between and attached to the sidewalls and the back wall,
a lower sequential arrangement of at least two box-shaped open-faced item bins is also provided within a central extent of the compartment between the upper dividing wall and the lower dividing wall, the lower sequential item bins being defined by partitions, each partition being received between the upper dividing wall bottom surface and the lower dividing wall top surface, and
a third compartment attached to the other side wall and comprising a outer wall, a pair of side walls attached to the other side wall and to the third compartment outer wall, and a bottom wall attached to both of the third compartment side walls and the third compartment outer wall.

3. An organizer in accordance with claim 1 wherein said organizer further includes means for also provided for permitting the cabinet to be hung on an office or home wall is also attached to the cabinet and
hanging means is in the form of triangular-shaped wires pivotally attached to the top of the back wall.

4. An organizer in accordance with claim 1 wherein said organizer further includes means for labeling each of the item bins, such labeling means comprising tag receiving frames, each of which is attached to a dividing wall beneath each bin, a tag or label may then be marked appropriately and then placed in a respective frame.

5. An organizer in accordance with claim 1 wherein said top edge of the second compartment outer wall is notched to provide easier access to any items within the second compartment.

6. An organizer in accordance with claim 1 wherein said top edge of the third compartment outer wall is notched to provide easier access to any items within the third compartment.

7. An organizer including a cabinet comprising
a horizontal bottom wall with a front edge, a rear edge, and opposed side edges,
a pair of opposed sidewalls attached to and extended upwards from the side edges of the bottom wall, a horizontal top wall attached to an upper extent of each sidewall,
a back wall connected between the sidewalls, the top wall, and the bottom wall to define a hollow compartment,
an upper horizontal dividing wall is spaced apart below the top wall and extends between and is attached to the sidewalls and the back wall,
a lower horizontal dividing wall is spaced apart below the top wall and extends between and is also attached to the sidewalls and the back wall,
an upper sequential arrangement of at least two box-shaped open-faced item bins is provided within a central extent of the compartment defined between the top wall and the upper dividing wall, the upper sequential item bins are defined by removable partitions, each partition being removably received in vertically aligned slots in the upper dividing wall top surface and the top wall bottom surface,
a lower sequential arrangement of at least two box-shaped open-faced item bins is also provided within a central extent of the compartment defined between the upper dividing wall and the lower dividing wall, the lower sequential item bins are defined by removable partitions, each partition being removably received in vertically aligned slots in the upper dividing wall bottom surface and the lower dividing wall top surface, each item bin is used for holding a selected individual or more items, each of these item bins has a front opening,
a plurality of key hooks attached to each sidewall,
a pen and pencil compartment attached to one side wall and comprising an outer wall with opposed vertically extending side edges attached to the one side wall, a bottom wall with a outer edge attached to the pen and pencil compartment outer wall, and a straight edge attached to the one side wall,
a small card compartment attached to this one side wall and including an outer wall, a pair of side walls attached to the one side wall and to the small card compartment outer wall, and a bottom wall attached to both of the small card compartment side walls and the small card compartment outer wall, the pen and pencil compartment and the small card compartment sit in front to back horizontal order in about the middle of the one sidewall, with the key hooks located beneath the compartments, the top and bottom edges of the pen and pencil compartment and the small card compartment are about the same horizontal top and bottom planes, respectively, and
attached to the other side wall is an envelope compartment including a outer wall, a pair of side walls attached to the other side wall and to the envelope compartment outer wall, and a bottom wall attached to both of the envelope compartment side walls and the envelope compartment outer wall, the bottom of the envelope compartment sits about one third of the way up the other side wall, with the key hooks located beneath the compartment, and is about twice as long as the small card compartment and about one third wider.

8. An organizer in accordance with claim 7 wherein said organizer further includes means for also provided for permitting the cabinet to be hung on an office or home wall is also attached to the cabinet.

9. An organizer in accordance with claim 8 wherein said organizer further includes hanging means is in the form of triangular-shaped wires pivotally attached to the top of the back wall.

10. An organizer in accordance with claim 7 wherein said organizer further includes means for labeling each of the item bins, such labeling means comprising tag receiving frames, each of which is attached to a dividing wall beneath each bin, a tag or label may then be marked appropriately and then placed in a respective frame.

11. An organizer in accordance with claim 7 wherein said top edge of the small card compartment outer wall is notched to provide easier access to any cards within the small card compartment.

12. An organizer in accordance with claim 7 wherein said top edge of the envelope compartment outer wall is notched to provide easier access to any envelopes within the envelope compartment.

13. An organizer in accordance with claim 7 wherein said bottom wall front edge further includes a railing for preventing items from easily sliding out of the bottom extent of the compartment.

14. An organizer in accordance with claim 7 wherein said railing is formed from a top strip and a plurality of spaced apart cylindrical posts extending vertically between the top strip and the bottom wall front edge.

15. An organizer including a cabinet comprising
a horizontal rectangular planar bottom wall with an added curved front planar edge, a rear edge, and opposed side edges,
a pair of opposed rectangular planar sidewalls attached to and extended upwards from the side edges of the bottom wall,
a horizontal rectangular planar top wall attached to an upper extent of each sidewall,
a planar back wall connected between the sidewalls, the top wall, and the bottom wall to define a hollow compartment,
an upper horizontal rectangular planar dividing wall is spaced apart below the top wall and extends between and is attached to the sidewalls and the back wall,
a lower horizontal rectangular planar dividing wall is spaced apart below the top wall and extends between and is also attached to the sidewalls and the back wall,
an upper sequential arrangement of four box-shaped open-faced item bins is provided within a central extent of the compartment between the top wall and the upper dividing wall, the upper sequential item bins are defined by removable partitions, each partition being removably received in vertically aligned slots in the upper dividing wall top surface and the top wall bottom surface,
a lower sequential arrangement of four box-shaped open-faced item bins is also provided within a central extent of the compartment between the upper dividing wall and the lower dividing wall, the lower sequential item bins are defined by removable partitions, each partition being removably received in vertically aligned slots in the upper dividing wall bottom surface and the lower dividing wall top surface, each item bin is used for holding a selected individual or more items, each of these item bins has a rectangular front opening,
a plurality of key hooks attached to each sidewall,
a pen and pencil compartment attached to one side wall and comprising a curved outer wall with opposed vertically extending side edges attached to the one side wall, a planar bottom wall with a curved outer edge attached to the pen and pencil compartment outer wall, and a straight edge attached to the one side wall,
a small card compartment attached to this one side wall and including an outer planar rectangular wall, a pair of planar rectangular side walls attached to the one side wall and to the small card compartment outer wall, and a bottom planar rectangular wall attached to both of the small card compartment side walls and the small card compartment outer wall,
wherein the pen and pencil compartment and the small card compartment sit in front to back horizontal order in about the middle of the one sidewall, with the key hooks located beneath the compartments, the top and bottom edges of the pen and pencil compartment and the small card compartment are about the same horizontal top and bottom planes, respectively, and
attached to the other side wall is an envelope compartment with a outer planar rectangular wall, a pair of planar rectangular side walls attached to the other side wall and to the envelope compartment outer wall, and a bottom planar rectangular wall attached to both of the envelope compartment side walls and the envelope compartment outer wall,
wherein the bottom of the envelope compartment sits about one third of the way up the other side wall, with the key hooks located beneath the compartment, and is about twice as long as the small card compartment and about one third wider.

16. An organizer in accordance with claim 15 wherein said organizer further includes means for also provided for permitting the cabinet to be hung on an office or home wall is also attached to the cabinet.

17. An organizer in accordance with claim 15 wherein said organizer further includes means for labeling each of the item bins, such labeling means comprising tag receiving frames, each of which is attached to a dividing wall beneath each bin, a tag or label may then be marked appropriately and then placed in a respective frame.

18. An organizer in accordance with claim 15 wherein said top edge of the small card compartment outer wall is notched to provide easier access to any cards within the small card compartment, and
wherein said top edge of the envelope compartment outer wall is notched to provide easier access to any envelopes within the envelope compartment.

19. An organizer in accordance with claim 15 wherein said bottom wall front edge further includes a railing for preventing items from easily sliding out of the bottom extent of the compartment.

20. An organizer in accordance with claim 15 wherein said railing is formed from a top strip and a plurality of spaced apart cylindrical posts extending vertically between the top strip and the bottom wall front edge.
